(19) United States
(12) Patent Application Publication
(10) Pub. No.: US 2009/0242370 A1
(43) Pub. Date: Oct. 1, 2009

(54) LIGHT-GUIDING STRUCTURE, METHOD OF MANUFACTURING THE SAME AND LIGHT-EMITTING KEYBOARD USING THE SAME

(75) Inventor: Chih-Hsiang Chiang, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DARFON ELECTRONICS CORP., Taoyuan (TW)

(21) Appl. No.: 12/411,447

(22) Filed: Mar. 26, 2009

(30) Foreign Application Priority Data
Apr. 1, 2008 (TW) 97111865

(51) Int. Cl. H01H 9/00; B23P 19/04; F21V 7/22

(52) U.S. Cl. 200/314; 29/238; 362/615

(57) ABSTRACT

A light-guiding structure, a method of manufacturing the same and a light-emitting keyboard using the same are provided. The method of manufacturing the light-guiding structure includes the following steps. Firstly, a reflecting plate is placed on a light-guiding plate. Then, a compress-bond process is performed on the light-guiding plate and the reflecting plate by using a die having a die pattern, so that the reflecting plate is fixed onto the light-guiding plate, and a first compressed pattern and a second compressed pattern are formed on the light-guiding plate and the reflecting plate, respectively. The first compressed pattern and the second compressed pattern both correspond to the die pattern.

This application claims the benefit of Taiwan application Serial No. 97111865, filed Apr. 1, 2008, the subject matter of which is incorporated herein by reference.

### BACKGROUND OF THE INVENTION

1. Field of the Invention

The invention relates in general to a light-guiding structure, a method of manufacturing the same and a light-emitting keyboard using the same, and more particularly to a light-guiding structure made by compressing and bonding, a method of manufacturing the same and a light-emitting keyboard using the same.

2. Description of the Related Art

Light-emitting electronic devices are popular in people's daily life. When a light-emitting area of an electronic device is designed to be wider, a light-guiding structure is disposed in the electronic device to be used for enabling the light to be uniformly distributed over the light-emitting area. The light-guiding structure includes a light-guiding plate and a reflecting plate. The reflecting plate is used for reflecting the light to the light-guiding plate. The light-guiding structure has a pattern enabling the light to be uniformly distributed over a light-emitting surface of the light-guiding structure.

In the conventional method of manufacturing the light-guiding structure, a printing pattern is formed on the light-guiding plate by printing a coating first. After the coating is dried or shaped, a side of the light-guiding plate with the printing pattern is combined with the reflecting plate by a mechanism or a double-sided adhesive tape. Or, a pattern is formed on a surface of the light-guiding plate first, and the light-guiding plate is then combined with the reflecting plate by a mechanism or a double-sided adhesive tape. However, the two methods of manufacturing the light-guiding structures are both time-consuming and inconvenient. Furthermore, the reflecting plate may damage the printing pattern to cause defects during the assembly of the light-guiding plate and the reflecting plate. Thus, how to provide a light-guiding structure and a method of manufacturing the same which reduces manufacturing time to reduce the cost has become a focus to the manufacturers.

### SUMMARY OF THE INVENTION

The invention is directed to a light-guiding structure, a method of manufacturing the same and a light-emitting keyboard using the same. The invention is to form a pattern on the light-guiding plate and to simultaneously fix a reflecting plate onto the light-guiding plate by only one manufacturing process, hence reducing manufacturing time and cost.

According to an aspect of the present invention, a method of manufacturing a light-guiding structure is provided. The method comprises the following steps. Firstly, a reflecting plate is placed on a light-guiding plate. Then, a compress-bond process is performed on the light-guiding plate and the reflecting plate by using a die having a die pattern, so that the reflecting plate is fixed onto the light-guiding plate, and a first compressed pattern and a second compressed pattern are formed on the light-guiding plate and the reflecting plate, respectively. The first compressed pattern and the second compressed pattern both correspond to the die pattern.

According to another aspect of the present invention, a light-guiding structure is provided. The light-guiding structure comprises a light-guiding plate and a reflecting plate. The light-guiding plate has a first surface and a second surface opposite to each other. The second surface is a light-emitting surface of the light-guiding plate. The first surface has a first compressed pattern. The reflecting plate has a second compressed pattern. The reflecting plate is fixed onto the light-guiding plate through compress-bond process. The first compressed pattern and the second compressed pattern are formed through a compress-bond process.

According to still another aspect of the present invention, a light-emitting keyboard is provided. The light-emitting keyboard comprises a light-emitting device, a light-guiding structure and a keyboard. The light-emitting device is for providing light. The light-guiding structure is for receiving the light and comprises a light-guiding plate and a reflecting plate. The light-guiding plate has a first surface and a second surface opposite to each other. The second surface is a light-emitting surface of the light-guiding plate. The first surface has a first compressed pattern. The reflecting plate has a second compressed pattern. The reflecting plate is bonded to the first surface through the second compressed pattern. The keyboard has a plurality of light-previous keys and is disposed on the second surface. The light which is reflected by the first compressed pattern is guided to keyboard through the second surface.

The invention will become apparent from the following detailed description of the preferred but non-limiting embodiments. The following description is made with reference to the accompanying drawings.

### BRIEF DESCRIPTION OF THE DRAWINGS

FIG. 1 shows a flowchart of a method of manufacturing a light-guiding structure according to a preferred embodiment of the present invention;

FIGS. 2A˜2E sequentially show the steps of the method of manufacturing the light-guiding structure in FIG. 1 by cross-sectional views; and

FIG. 3A and FIG. 3B respectively show a top view and a cross-sectional view of a light-emitting keyboard using a light-guiding structure of the embodiment of the present invention.

### DETAILED DESCRIPTION OF THE INVENTION

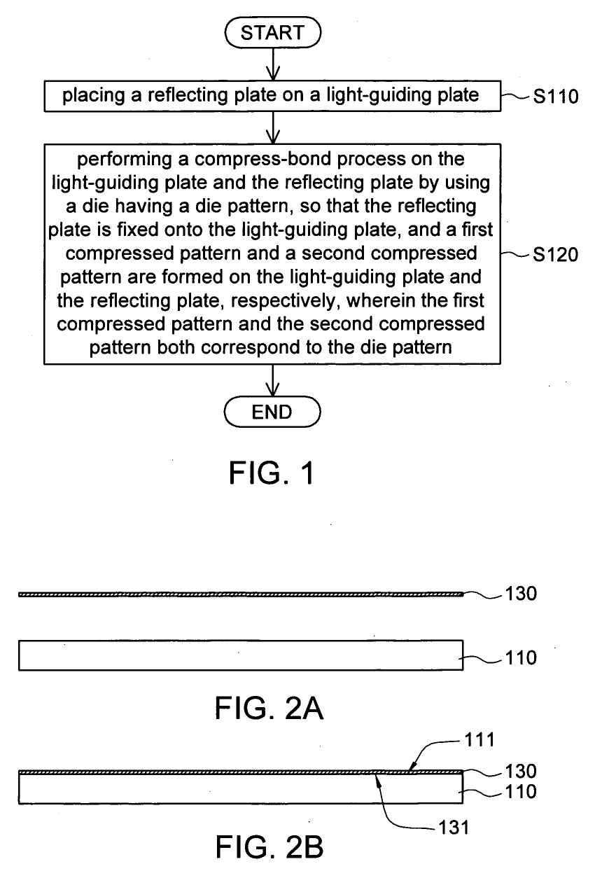

Referring to FIG. 1, a flowchart of a method of manufacturing a light-guiding structure according to a preferred embodiment of the present invention is shown. The method of manufacturing the light-guiding structure mainly includes the following steps. In the step S110, a reflecting plate is placed on a light-guiding plate. In the step S120, a compress-bond process is performed on the light-guiding plate and the reflecting plate by using a die having a die pattern, so that the reflecting plate is fixed onto the light-guiding plate, and a first compressed pattern and a second compressed pattern are formed on the light-guiding plate and the reflecting plate, respectively. The first compressed pattern and the second compressed pattern both correspond to the die pattern. According to the method disclosed above, the compressed patterns are formed when the light-guiding plate and the reflecting plate are compressed and bonded, hence saving manufacturing time and procedures. Each step of the method is further elaborated below.

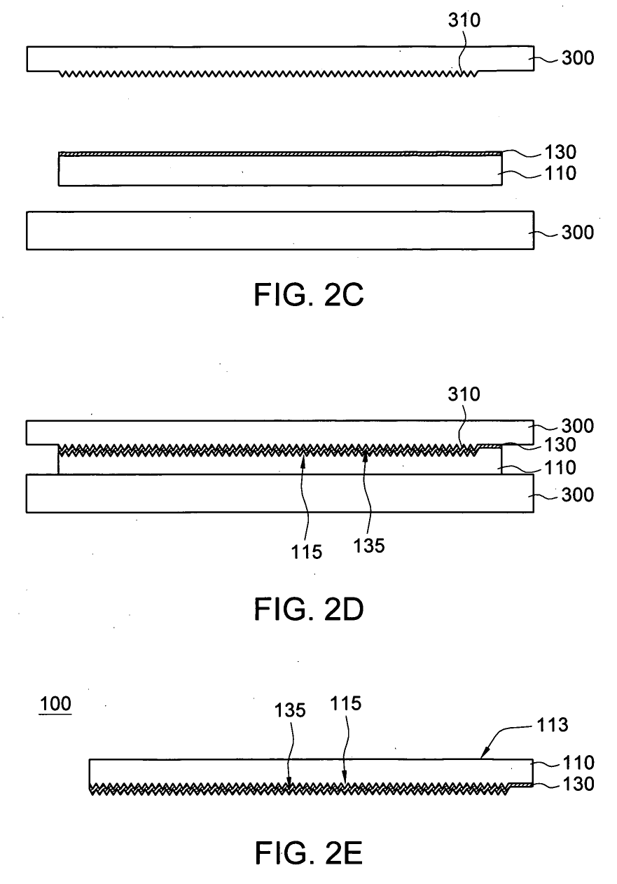

Referring to FIG. 1 and FIGS. 2A˜2E at the same time, FIGS. 2A˜2E sequentially show the steps of the method of manufacturing the light-guiding structure in FIG. 1 by cross-sectional views.

As shown in FIG. 2A, firstly, a light-guiding plate 110 and a reflecting plate 130 are provided. The light-guiding plate 110 is, for example, a flat type light-guiding plate.

As shown in FIG. 2B, the light-guiding plate 110 has a surface 111, and the reflecting plate 130 has a surface 131. In the step S110, the reflecting plate 130 is placed on the light-guiding plate 110. At this time, the surface 131 of the reflecting plate 130 contacts with the surface 111 of the light-guiding plate 110.

The detailed steps of the step S120 are elaborated by accompanying with FIG. 2C and FIG. 2D. Firstly, a die 300 having a die pattern 310 is provided. As shown in FIG. 2C, the die pattern 310 is, for example, a pattern with protrusions and indentations. The die pattern 310 is used for forming a corresponding optical pattern on the light-guiding plate 110.

Then, as shown in FIG. 2D, a compress-bond process is performed on the light-guiding plate 110 and the reflecting plate 130 by using the die 300 having the die pattern 310. Preferably, the die 300 is a hot pressing die, and the compress-bond process is a hot pressing process. Through the hot pressing process, the reflecting plate 110 is fixed onto the light-guiding plate 130 and the compressed pattern 115 and the compressed pattern 135 are simultaneously formed on the light-guiding plate 110 and the reflecting plate 130, respectively. The compressed pattern 115 and the compressed pattern 135 both correspond to the die pattern 310, and the compressed pattern 115 is the optical pattern of the light-guiding plate 110.

After the die 300 is removed, the light-guiding structure 100 is formed as illustrated in FIG. 2E. The light-guiding structure 100 includes the light-guiding plate 110 having the compressed pattern 115 and the reflecting plate 130 having the compressed pattern 135. As the compressed pattern 115 and 135 are formed through the compress-bond process, the compressed patterns 115 and 135 are substantially the same. As the compressed pattern 115 is the optical pattern designed for the light-guiding plate 110, the light-guiding structure 100 formed through the above steps can guide the light to the surface 113 of the light-guiding plate 110. The surface 113 is a light-emitting surface of the light-guiding plate 110.

Through the compress-bond process of the method of manufacturing the light-guiding structure according to the embodiment of the present invention, not only the light-guiding plate 110 and the reflecting plate 130 are compressed and bonded to fix the reflecting plate 130 onto the light-guiding plate 110, but the compressed pattern is also simultaneously formed on the light-guiding plate 110. Therefore, the combination of the reflecting plate and the light-guiding plate and the formation of the compressed patterns can be accomplished in only one step, hence saving time for manufacturing the light-guiding structure 100 and reducing the cost.

The light-guiding structure of the above-disclosed embodiment can be further used in a light-emitting electronic device. The light-emitting electronic device is exemplified by a light-emitting keyboard. However, the present invention is not limited thereto. The present embodiment can be applied to any electronic device which adopts a light-guiding structure.

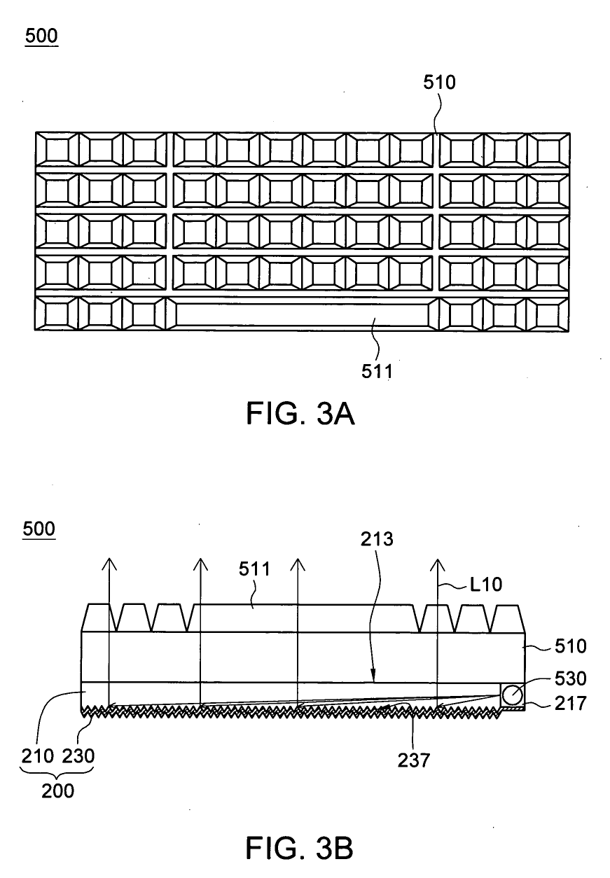

Referring to both FIG. 3A and FIG. 3B, a top view and a cross-sectional view of a light-emitting keyboard using a light-guiding structure of the embodiment of the present invention are shown, respectively. The light-emitting keyboard 500 includes a light-emitting device 530, a light-guiding structure 200 and a keyboard 510. The light-emitting device 530 is for providing light L10. The light-guiding structure 200 is for receiving the light L10 and includes a light-guiding plate 210 and a reflecting plate 230. The keyboard 510 includes several light-previous keys 511 and is disposed on the surface 213 of the light-guiding plate 210. The light L10 which is reflected by the compressed pattern 237 is guided to the keyboard 510 through the surface 213.

As shown in FIG. 3B, the light-guiding structure 200 used in the electronic device differs from the light-guiding structure 100 disclosed above in that the light-guiding plate 210 further has a space 217 for containing the light-emitting device 530. The light-emitting device 530 is preferably contained in the space 217 of the light-guiding plate 210 in a mechanical way. For example, the light-emitting device 530 is fixed on the reflecting plate 230. Except for the design that the light-guiding plate 210 has the space 217, the design of the light-guiding structure 200 is identical to the light-guiding structure 100. Thus, the same features are not repeatedly described herein.

The light-emitting device 530 includes at least one light-emitting diode (LED), for example. Preferably, the light-emitting device 530 is a row of LEDs disposed at a side of the light-guiding plate 210. The light-guiding structure 200 is used for converting the light L10 provided by the light-emitting device 530 from a line light source into a planar light source and further guiding the planar light source to the keyboard 510.

According to the light-guiding structure, the method of manufacturing the same and the light-emitting keyboard using the same disclosed in the embodiments of the invention, the die pattern and the compressed patterns are exemplified by identical and continuous patterns. However, anyone who is skilled in the technology of the invention should understand that the above exemplifications are not for limiting the scope of the present invention. The die pattern can be various patterns and any compressed pattern which can be formed on the light-guiding plate to guide the light is within the scope of the present invention. In addition, the light-emitting device of the present embodiment is contained in the space of the light-guiding plate. However, the light-emitting device can also be disposed other locations within the light-guiding plate or disposed at a position outside but near the light-guiding plate.

According to the light-guiding structure, the method of manufacturing the same and the light-emitting keyboard using the same disclosed in the above embodiments of the present invention, the compressed pattern of the reflecting plate corresponds to the compressed pattern of the light-guiding plate. Through the compress-bond process, the light-guiding plate and the reflecting plate are bonded together, and the compressed patterns for guiding the light are simultaneously formed. The method of manufacturing the light-guiding structure of the present embodiment does not need to print a coating onto the light-guiding plate to form an optical pattern, so that the waiting time for shaping the coating is saved. Also, the conventional steps of forming an optical pattern on the light-guiding plate first and then aligning and bonding the light-guiding plate with the reflecting plate can be omitted. Through the compress-bond process of the present embodiment, the light-guiding plate and the reflecting plate are bonded together and the corresponding compressed patterns are formed on the reflecting plate and the light-guiding plate, so that the light is guided to the light-emitting surface through the compressed patterns. The method of manufacturing the light-guiding structure of the present embodiment has the advantages that the manufacturing process is simple and fast and the cost is reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of manufacturing a light-guiding structure, the method comprises:
(a) placing a reflecting plate on a light-guiding plate; and
(b) performing a compress-bond process on the light-guiding plate and the reflecting plate by using a die having a die pattern, so that reflecting plate is fixed onto the light-guiding plate, and a first compressed pattern and a second compressed pattern are formed on the light-guiding plate and the reflecting plate, respectively, wherein the first compressed pattern and the second compressed pattern both correspond to the die pattern.

2. The method according to claim 1, wherein the die is a hot pressing die, and in the step (b), the compress-bond process is a hot pressing process.

3. A light-guiding structure, comprising:
a light-guiding plate having a first surface and a second surface opposite to each other wherein the second surface is a light-emitting surface of the light-guiding plate, and the first surface has a first compressed pattern; and
a reflecting plate having a second compressed pattern, wherein the reflecting plate is fixed onto the light-guiding plate through a compress-bond process, and the first compressed pattern and the second compressed pattern are formed through the compress-bond process.

4. The light-guiding structure according to claim 3, wherein the first compressed pattern and the second compressed pattern are substantially the same.

5. The light-guiding structure according to claim 3, wherein the light-guiding plate is a flat type light-guiding plate.

6. A light-emitting keyboard, comprising:
a light-emitting device for providing light;
a light-guiding structure for receiving the light, wherein the light-guiding structure comprises:
a light-guiding plate having a first surface and a second surface opposite to each other, wherein the second surface is a light-emitting surface of the light-guiding plate, and the first surface has a first compressed pattern; and
a reflecting plate having a second compressed pattern, wherein the reflecting plate is bonded to the first surface through the second compressed pattern; and
a keyboard having a plurality of light-previous keys and disposed on the second surface;
wherein, the light which is reflected by the first compressed pattern is guided to the keyboard through the second surface.

7. The light-emitting keyboard according to claim 6, wherein the first compressed pattern and the second compressed pattern are substantially the same.

8. The light-emitting keyboard according to claim 6, wherein the light-guiding plate is a flat type light-guiding plate.

9. The light-emitting keyboard according to claim 6, wherein the light-guiding plate further has a space for containing the light-emitting device.

10. The light-emitting keyboard according to claim 6, wherein the light-emitting device comprises at least one light-emitting diode (LED).
